(19) United States
(12) Patent Application Publication
(10) Pub. No.: US 2008/0195625 A1
(43) Pub. Date: Aug. 14, 2008

(54) Interactive credential system and method

(76) Inventor: Dwayne Paul Hargroder, Opelousas, LA (US)

Correspondence Address: LITMAN LAW OFFICES, LTD., P.O. BOX 15035, CRYSTAL CITY STATION, ARLINGTON, VA, 22215, US

(21) Appl. No.: 12/081,130

(22) Filed: Apr. 10, 2008

Related U.S. Application Data
(63) Continuation-in-part of application No. 11/710,885, filed on Feb. 26, 2007.
Application No. 11/710,885 is a continuation-in-part of application No. 11/480,679, filed on Jul. 3, 2006.

(30) Foreign Application Priority Data
Jun. 27, 2007 (US) PCT/US2007/014854

(51) Int. Cl. G06F 17/30

(52) U.S. Cl. 707/9; 707/E17.005

(57) ABSTRACT

An interactive credential system and method is provided. The system comprises a database containing employee-employer-applicant surveyed information, industry specific criteria such as insurance loss history and account performance, an authorization code for authorizing access to the database and a control device, operatively associated with the database, for presenting weighted scores. The system further includes a surveyed party processor operatively associated with the control device, and wherein the surveyed party processor is capable of transmitting the authorization code to view the surveyed information. The system further comprises a participant processor that is capable of requesting authorization to download the employee-employer-applicant information, including weighted scores computed from the system's algorithms processed from industry specific parameters.

### CROSS-REFERENCE TO RELATED APPLICATIONS

This application is a continuation-in-part of U.S. patent application Ser. No. 11/710,885, filed on Feb. 26, 2007, which was filed as a continuation-in-part of U.S. patent application Ser. No. 11/480,679, filed on Jul. 3, 2006.

### BACKGROUND OF THE INVENTION

1. Field of the Invention

The present invention relates to the information technology industry for the systematic implementation of resource management using employee-employer-applicant dynamics and participant surveys. More specifically, but not by way of limitation, the present invention relates to an interactive credential system and method incorporating industry specific parameters for evaluation and subsequent scoring with emphasis on a proprietary method of employment, insurance and finance information processing.

2. Description of the Related Art

As the insurance industry has incorporated the use of Medical Information Bureaus (MIB's) for Life and Health Insurance underwriting and Motor Vehicle Reports (MVR's) and claims information provided by “CLUE” for property and casualty insurance risks, this invention, in one embodiment, is designed to launch an internet site to provide real time employee credentials for employment and insurance underwriting by full disclosure of prior work history, performance and specialized credentials while eliminating insurance information processing deficiencies that currently exist in the prior art.

The system herein disclosed consists of an interactive web-based information resource center for the management of employee credentials as well as prior work history and performance as reported by industry sources. The system may include a certification program to award all companies that incorporate the system for the maintenance of current employees, new hires, as well as the real time processing of pertinent information critical to industries such as insurance and finance. The system allows for a second tier of performance information for employers and independent contractors in order to provide consumers with full disclosure of employer past performance and weighted scoring. The system may include the launching of a secure business web site through the incorporation of password protection and personal pin numbers to insure the privacy of each applicant's scoring and the restriction of use by unauthorized personnel. Such a system of industry specific criteria evaluated, scored and monitored does not exist in the prior art.

In another embodiment, an interactive credential system and method that utilizes a survey system is also disclosed. Survey information of a surveyed party is compiled from various respondents. The survey information is used by participants of the system, as fully disclosed in the description of the preferred embodiments.

Therefore, there is a need for an on-demand systematic real time performance scoring method as a management tool in order to improve the underwriting process of insurance policies, credit provisions, as well as the management of employees with industry specific credentials. By virtue of the disclosed system, member companies will experience economic efficiencies from the reduction of Human Resource activity for new hire verification, reference checks on discharged employees, and insurance cost savings by the improved management practices and improved safety records by program implementation. Additionally, as the insurance industry has incorporated multiple tools for underwriting consideration, the current methods fall short of real time analysis and measurable non-discriminatory indexes, therefore, there is a need for a single interactive credential system and method, wherein an entity can be surveyed by various respondents and scored by actual insurance performance based upon premium development vs claims experience adjusted for insurance performance indicators such as insurance payment history, non-renewals, cancellations, misrepresentations, etc. with weighted results calculated and made available to selected participants.

Prior to the establishment of credit bureaus, many businesses were forced to verify credit ratings on prospective clients, prior to the granting of credit, based upon the disclosure of the prospective client's credit facilities and payment history. This effort was time consuming and costly to the prospective creditors, as each disclosed creditor would have to be contacted manually for a “credit rating” or payment history. Thus, if your prospective client had established credit with Sears, JC Penny, Joe's Hardware, Visa, etc., it was imperative that each individual creditor disclose individual ratings and payment history in order for new credit facilities to properly underwrite the credit risk.

This process was costly, as it required additional credit personnel in order to gather the credit information to establish the credit worthiness of the applicant and the establishment of a new line of credit. Many credit facilities had limited hours of operation for this specific tasks and restricted many retailers from establishing credit for point of sale transactions.

After undergoing a financial revolution, whereby credit information was consolidated into a clearing house, scored and then made available to prospective credit facilities for a nominal charge with the touch of a keystroke, many of these problems were alleviated.

As the present insurance industry shares many of the deficiencies of the early years of credit bureaus, a new business model and method is required to similarly revolutionize the commercial and personal insurance industry.

Currently the commercial insurance industry is impaired by underwriting inefficiencies, due to the lack of access to complete real time loss history available at point of sale to be utilized in the underwriting process, much like the credit industry of the past. Currently, the industry requires the manual assembly of prior loss experience from three to five years of previous coverages provided by each insurance company for each policy period by line of coverage for underwriting consideration. Although each company could make electronic data available to insureds, the process would still be time consuming for the retrieval of each detailed policy history, but most importantly, would lack the detail of automation and the consolidated analysis of all prior years as requested by prospective insurers for trending. Example, if the insured has been insured by 3 insurance companies over the past 5 years, the information retrieved by company A would not reflect information for company B and C. Therefore, the need for the collection of all data, consolidation, evaluation, assessment and subsequent scoring of the present method.

Many states have enacted laws that require insurance companies to provide the policy holder with their loss experience with a request properly executed with name, policy number, policy period, etc. Many states have enacted laws specifying a maximum number of days that the insurance company has to comply. As an example, Louisiana law provides that an insurance company must provide this information within 60 days of a duly executed request. Therefore, U.S. commercial insurance policy holders are disadvantaged by the process of choosing new insurers due to the time delay and the effort to seek their previous loss runs from several companies within the 3-5 year previous history.

Insurance companies can hold this provision as leverage against a current policy holder, as some will “hold out” until the final deadline in order to prevent their insured from seeking other competitive bids. Further, many insurance companies will not quote a new risk without a completed application along with the required loss runs attached in order to properly evaluate the risk. Also, insurers are disadvantaged by the “static” information which requires the constant request of updated history, as the loss history may change for years after receipt due to the delay in the legal system and litigation time frame due to docket congestion.

John Doe, as an example, may have a loss recorded on his loss run with a large “reserve” posted and expected to pay, only to have the courts award a judgment more or less than the reserve, and the loss runs will be adjusted to reflect an increase or decrease in renewal premium based on the action. Therefore, updated loss runs are necessary for accurate underwriting and, each year, insurance companies will request updated information to determine eligibility or appropriate pricing. Existing experience modifiers available today for general liability and workers compensation insurance provided by bureau associations fall short of real time data as they reflect a time when loss history worksheets had to be assembled after each policy period and mailed to the associations to be placed in line for processing with other risk of the same classification, therefore, this method continues to provide data that is a staggering minimum of 12 months old but only reflects actual reported loss information on each risk as compared to others in the same classification. The disclosed method proposes a global authorization executed by insured at point of sale by affidavit or part of the standard application much like credit application disclosures for the release of credit, satisfying the request for all previous loss history performance by company for electronic data distribution to the present system for an individual loss history evaluation by previous company, by policy period, modified by insurance account performance indicators in order to objectively score the actual risk performance in real time while making available premium and loss statistics by classification for future rate promulgation.

Many states provide a minimum number of days required for an insurance company to issue non-renewal or cancellation of a poor performing risk and therefore, up to date real time loss information at the touch of a keystroke is required to reduce insurance company expense ratios through the implementation of improve operational efficiencies, a reduction in claim frequency and severity resulting in lower premiums for the policyholders. These needs, and many others, will be met by the following described system.

### SUMMARY OF THE INVENTION

In a first preferred embodiment, the system will provide baseline credentials containing industry specific criteria with automatic updating of time sensitive information. Certifications and continuing education requirements will be updated instantaneously and reflect status of such requirements. The system can provide for automatic downloads with certification agencies and specific industries in order to receive real time information electronically in an approved format.

A sample illustrative list of agencies that can communicate data includes: the State Real Estate Commission, Insurance Companies, Mortgage Lenders, Legal and Bar Associations, Barbers, Hair Dressers, State Board of Nursing, and other approved certification agencies. The collected information will be processed by a proprietary algorithm with subsequent scoring available to all member companies through client authorization much like credit reports.

The database of employment/applicant records and industry specific criteria such as insurance scores, etc. will then be available for a nominal fee to authorized users. All employees in the system shall have identification cards with specified identification numbers that can be made available to the human resources departments to pull employment records within seconds. The system creates an employment database that will receive all information regarding that applicant's profession, duration of employment, special achievements/certifications, industry specific criteria and the current status of each. A real time resume that has been evaluated through a series of algorithmic computations and scored for numeric assessment of groups and sub groups constantly updated in real time and monitored through electronic alerts is possible with the teachings of this invention.

In this first embodiment, a provision can be included to better educate the consumers about artesian contractors, like carpenters, roofers, electricians, etc. These members could have performance scores available to customers prior to work engagement as scored by insurance companies based upon prior claim performance and customer satisfaction evaluated by premium size, policy duration, and complaint filings in order for full disclosure of job performance. These complaint filings will be in the form of a complaint similar to a complaint filed on an insurance company with the department of insurance, however, unlike this method, prior methods have failed to provide performance disclosure on individual insureds in order to protect consumers from fraud and abuse.

In a second preferred embodiment, an interactive credential system is disclosed. The system comprises a database containing employee information, authorization means for authorizing access to the database and control means, operatively associated with the database, for presenting the employee information in a first format. The employee information is processed through an algorithm utilizing several hundred employment dynamics as well as industry specific scoring assessments such as insurance and financial indicators in order to compute an employer-employee-applicant weighted score. The interactive system provides for an authorization code for authorizing access to the database and control device, operatively associated with the database, in order for disclosure of score presentation. The system further includes an employee processor operatively associated with the control means, and wherein the employee processor is capable of transmitting authorization to view the employee information.

In this second embodiment, the system further comprises an employer processor in communication with the authorization means, and wherein the employer processor is capable of requesting authorization to download the employee information. The control means may contain means for requiring that the employer request includes payment of the request fee and means for requiring that the employee authorization includes payment of the request fee. In the most preferred embodiment, the first format of the employee information includes a weighted score performed by algorithm. The employee information may consist of health/drug testing information, education information, criminal information, and/or professional certification information, and industry specific scoring.

A method of providing employee information is also disclosed. The method comprises storing employee information on a database, such as employment performance evaluations transmitting authorization to view the employee information via an employee processor operatively associated with a control means, and authenticating and authorizing third parties access to the database. The method may further include presenting the employee information in a first format via the control means, and wherein the control means is operatively associated with the database.

The method may further comprise communicating an employer processor with the control means, and requesting authorization to download the employee information with the employer processor. In one embodiment, the step of requesting authorization to download employee information includes paying a request fee by the employer in order to view the employee information. Additionally, the step of transmitting authorization to make available employee information via an employee user processor may include paying a user fee by the employee in order to post the employee information to the database.

In a third embodiment, which is the most preferred embodiment of this disclosure, a method of providing survey information of a surveyed party is disclosed. The method comprises storing the survey information on a database, transmitting authorization to view the information via a surveyed party processor operatively associated with a control means, authenticating and authorizing third parties access to said database, and presenting the survey information in a first format via the control means, and wherein the control means is operatively associated with the database. The method further comprises communicating a participant processor with the control means and requesting authorization to download said survey information with the participant processor.

In one preferred embodiment, the step of requesting authorization to download the survey information includes paying a request fee by the participant in order to view the survey information. Also, the step of transmitting authorization to make available survey information via the surveyed party's processor includes paying a user fee by the surveyed party in order to post the surveyed party's information to the database. Additionally, the step of presenting the survey information in a first format includes utilizing an algorithm to calculate a weighted score of the survey information. The survey information is selected from the group consisting of a financial score, an academic score, an employment score, a character score, a medical score, a professional credential score, a reference score, a military score, a legal score or an insurance score. The method may also include transmitting an alert based on a predetermined criteria selected from the survey information. The participant may be selected from the group consisting of bankers, insurance companies, lenders, employers, and court systems.

In yet another most preferred embodiment, an interactive credential system is disclosed, wherein the system comprises a database comprising survey information of a surveyed party, authorization means for authorizing access to the database, and control means, operatively associated with the database, for presenting the survey information in a first format. This system also includes a survey party processor operatively associated with the control means, and wherein the survey party processor is capable of transmitting authorization to view the survey information, means for generating an alert when the survey information changes based on predetermined criteria, and means for transmitting the alert to participants in the system.

An advantage of the present method is that companies would finally have an accountability program for the management of their employees and new hires with full disclosure of numerical assessments of performance. Another advantage is that workers will have to be accountable in order to maintain adequate weighted scores which will contribute to enhanced job performance.

Yet another advantage is that probation periods will be available for individuals that have experienced hard luck situations and have the opportunity to improve their scores. Another advantage is that companies could use these scores for merit pay and the incentive of good performers. Yet another advantage is that it is possible that companies that maintain a “threshold or average” employment of weighted scores of some predetermined level would receive special recognition and would be entitled to premium credits on large insurance programs.

Still yet another advantage is that employers will experience a reduced workload by not having to ever give a reference on an employee, and instead can log-on and download the appropriate file. Another advantage is that attorneys could use certain authorized information for discovery purposes. For instance, it will be possible to obtain credential information immediately about certifications, safety certification expirations, etc. Also, the system could be used in conjunction with verifying employment information on deadbeat dads eliminating investigative costs to reattach garnishments to new employers.

Another advantage is that financial institutions will reduce loan losses by incorporating an additional underwriting tool that will provide real time employment disclosure and performance evaluation scoring which will enhance the predictability of an applicant's future ability to pay with the incorporation of electronic alerts for real time notification of job performance deterioration and employment termination. Another advantage is that insurance cost will be reduced (for employers) by premium credits available for the employment of applicants with a threshold benchmark weighted score. As an example, XYZ Insurance Company will provide premium credits to workers compensation insurance coverage for all risk that maintain an employment workforce with a weighted score of 500 or greater. This commitment reflects improved applicant hires and less risk for loss. Yet another advantage to the insurance industry is larger insurance participation as un-insured contractors will be forced into the system in order to continue working as customers will demand disclosure of insurance credentials and performance scores for verification.

Still yet another advantage is that hospitals and health care organizations like nursing homes will be protected by tracking all employees' specialized credentials and recurrent training as well as past performance evaluations by prior employment and subsequent numerical score assessment, by the present method. CPR and other specialized credentials will be updated through association-sponsored links, like Red Cross, etc. Also, hospitals that hire agency “pool” nurses for PRN (as needed) shifts will have complete disclosure of score performance of these health care professionals by the numerical assessment of the present system and method. Hospitals and Nursing Homes that are at risk due to poor background information on specific nurses that are sent at the last minute to simply cover nurse-patient ratios through agency pools will benefit from this method by real time disclosure of prior job performance and specialized credentials prior to work engagement protecting health care recipients.

Yet another advantage is that commercial entities will be able to protect themselves from the expiration of industry specific criteria such as CDL expirations for commercial trucking firms and will have a management tool for improved information disclosure on new hires, contract drivers and lease operations though score disclosure of past performance. The energy sector contains several industry specific training programs for various disciplines and the weighted score will become a source of acknowledgment and verification of completion by data links to these specific industry criteria. Real time full disclosure will be very important to cyclical industries which have been known to hire large numbers of employees in a short period of time and lack the manpower for comprehensive evaluations. The weighted score used in this invention will aid these cyclical industries with staffing by real time full disclosure and score assessment of prior work experience, certifications and achievements.

Another advantage is that the system will assist employees to be better employees in order to maintain their score and achieve compensation incentives/promotions for enhanced work performance. Yet another advantage is that the system will assist employers and independent contractors to be better businesses, as they will be subject to full disclosure of performance. An applicant can use the web or call a telephone number with a proper pin identification and obtain information regarding contractors.

A feature of the present invention is that the system allows for a one-stop shop for recordation of employee history, industry specific criteria, subsequent performance scoring and real time monitoring. Another feature is good performers can be recognized quickly and rewarded, while poor performers will not. Another feature is that incentive pay will induce employees to achieve better scores. Yet another feature is that it is possible that employees with good weighted performance scores and marginal credit scores will have the opportunity for credit accommodation, due to employment disclosure.

Another feature is that operational efficiencies will be experienced for all member companies with the reduction of human resource labor through the incorporation of automation and instantaneous file updating for minute-to-minute accuracy. Yet another feature is that an applicant can use the system as an updated resume. From the base line, all information will be updated instantaneously for real time accuracy. When a request exists for a resume, the applicant can reference the system. Once the applicant provides the personal identification code, access will be granted.

Another feature is that employer special achievement awards will be credited for enhancement of weighted scores, likewise, complaints filed against the employer will be harmful. As we have experienced the fragmentation of the present industry survey system without any meaningful consumer interpretation, this method seeks to achieve score standardization among all industries with consumer access to real time full disclosure.

An advantage of the third embodiment, which is the most preferred embodiment of this disclosure, includes protecting consumers from poor performing businesses. Another advantage is that the system has a component that allows for consumer evaluation and complaint processing of poor performance. Still yet another advantage is that the consumer can participate in the scoring of employers. Another advantage is that the system protects vendors from poor performing relationships and provides for vendor evaluation component. Vendors could establish benchmark scores as criteria for vendor list participation. Yet another advantage is that the most preferred embodiment of this disclosure allows for employee participation in the evaluation of the employer. This participation allows for constructive information on improving workplace environment, conditions, etc. Another advantage is that the system allows a means for prospective employees to analyze the employer by using the rating generated by the survey performance of existing employees of their employer. Still yet another advantage is that the process acknowledges specific industry associations to participate in the evaluation of members through evaluation surveys. Yet another advantage of this most preferred embodiment, the process allows for special accreditation programs to participate in the evaluation process and utilize the specially calculated and weighted score for compliance.

A feature of the third and most preferred embodiment is that parents and guardians will be able to rate/evaluate teachers by personal experience to provide disclosure for others making choices for their children. This process will aid teacher performance as they will have an incentive to achieve satisfactory measurement. Another feature of the most preferred embodiment is that clients of professionals will be able to voice opinions of personal experience for a quantified measurement rather than rely on word of mouth recommendations for specific professions. Therefore, the consumer will finally have recourse on poor performing professional relationships such as doctors, lawyers, etc. without litigation as a sole remedy.

### BRIEF DESCRIPTION OF THE DRAWINGS

FIG. 1 is a flow chart schematic depicting a first embodiment of the present novel system.

FIG. 2 is a flow chart schematic depicting a second embodiment of the present novel system.

FIG. 3 is a flow chart diagram depicting input factors for analysis and score weighing according to the present novel system.

FIG. 4 is a data flow chart of the third embodiment, which is the most preferred embodiment, illustrating the generation of an employer score based on multiple surveys.

FIG. 5 is a data flow chart of the third embodiment, which is the most preferred embodiment, illustrating the generation of a professional score based on multiple surveys.

FIG. 6 is a data flow chart of the third embodiment, which is the most preferred embodiment, showing the generation of alert transmissions to selected participants.

FIG. 7 is a data flow chart illustrating an insurance-specific implementation of the interactive credential system and method according to the present invention.

Similar reference characters denote corresponding features consistently throughout the attached drawings.

### DETAILED DESCRIPTION OF THE PREFERRED EMBODIMENTS

The system and method herein disclosed consists of an interactive web-based information resource center for the management of employee-employer-applicant credentials and industry specific criteria as well as prior work history and performance as reported by member resources. The site will assist employers in the management of their most important asset, their employees, as well as provide the public with full disclosure of employer's performance based upon insurance experience and participant surveys in order to protect the consumer from fraud and abuse. The created database collects employer credentials and insurance loss history and performance indicators for the application of employer performance base scoring. The system may incorporate employee/employer dynamics as well as the management of industry specific requirements, such as continuing education requirements, CPR certification for the medical industry, safety training for the energy sector, recurrent training for pilots, etc.

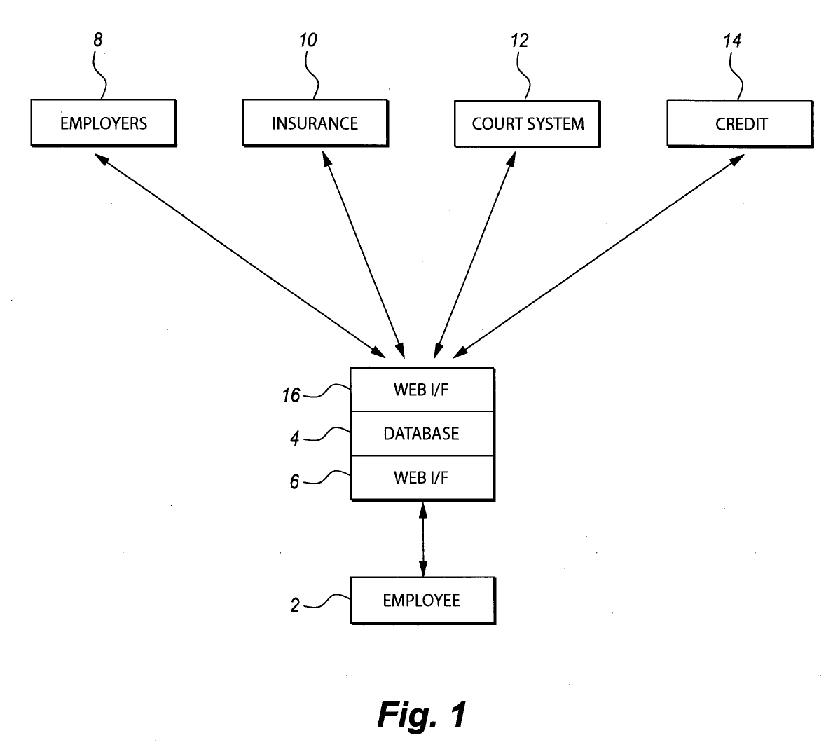

Referring now to FIG. 1, a flow chart schematic depicting a first embodiment of the present novel system will now be described. As shown in FIG. 1, an employee 2 would communicate with the database 4. In the most preferred embodiment, the employee 2 has an employee computer, also referred to as a user processor. The employee computer has means for communication with the Internet and the worldwide web.

As per the teachings of the system, the database 4 contains the web interface means 6 so that the employee computer can communicate with the database. The employee computer may communicate (e.g. via wireless transmission) data and information, including authorization to obtain data from various third party content custodians, as will be more fully explained below. The employee computer may also authorize payment of any fees required for use of the system.

FIG. 1 also depicts several entities that may provide information to the database 4 about the employee. For instance, employers may provide information to the database. Hence, employers 8 can provide this information to the database. FIG. 1 also depicts an insurance entity 10 that provides data for the database 4, a court system entity 12 that provides data for the database, and a credit entity 14 that provides data for the database. It should be understood that this listing of entities is illustrative only. In the most preferred embodiment, the employer entity 8, insurance entity 10, court system 12 and credit entity 14 will communicate with the database 4 via the Internet and worldwide web, as shown by the web interface 16, where the web interface 16 is operatively associated with the database 4. In this way, various entities can communicate data about an employee once the employee has submitted the proper authorization.

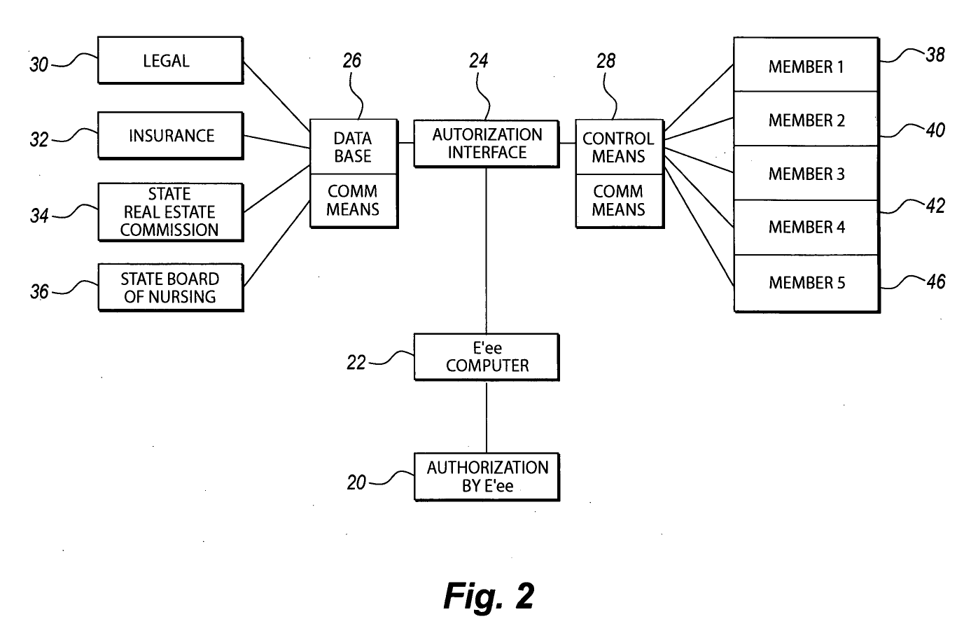

Referring now to FIG. 2, a flow chart schematic depicting a second embodiment of the present system will now be described. FIG. 2 is a higher level flow chart from the illustration of FIG. 1. In the embodiment of FIG. 2, an employee gives his authorization 20, and the authorization is sent via the employee computer 22 to authorization interface 24. As depicted, the authorization interface 24 is operatively associated with the database 26 and with the control means 28.

FIG. 2 depicts several entities that will supply data and information to the database 26. More specifically, a legal entity (such as a court system) 30 is shown in communication with the database 26; an insurance entity (such as an insurance company) 32 is shown in communication with the database 26; a state real estate commission 34 is shown in communication with the database 26; and, a state board of nursing 36 is shown in communication with the database 26. The listing of entities is meant to be exemplary and illustrative. The entities 30, 32, 34, and 36 will communicate with the database 26 via the worldwide web in the most preferred embodiment.

Various member entities will be in communication with the database. FIG. 2 depicts five member entities, but this listing is illustrative only. In one preferred embodiment, the member entities will pay a required fee to access the database 26 and any proprietary weighting score accomplished according to the teachings of the present invention. Hence, member entity 38 will communicate with the control means 28, which in turn will communicate with the authorization interface to check on authorization, and if there is authorization, then the member 38 will be allowed access to the data and information sought. FIG. 2 further shows the member 40 in communication with the control means, the member 42 in communication with the control means 28, the member 44 in communication with the control means 28, and the member 46 in communication with the control means 28. Members 40, 42, 44, and 46 receive authorization, information and data as mentioned earlier in the discussion of the member 38.

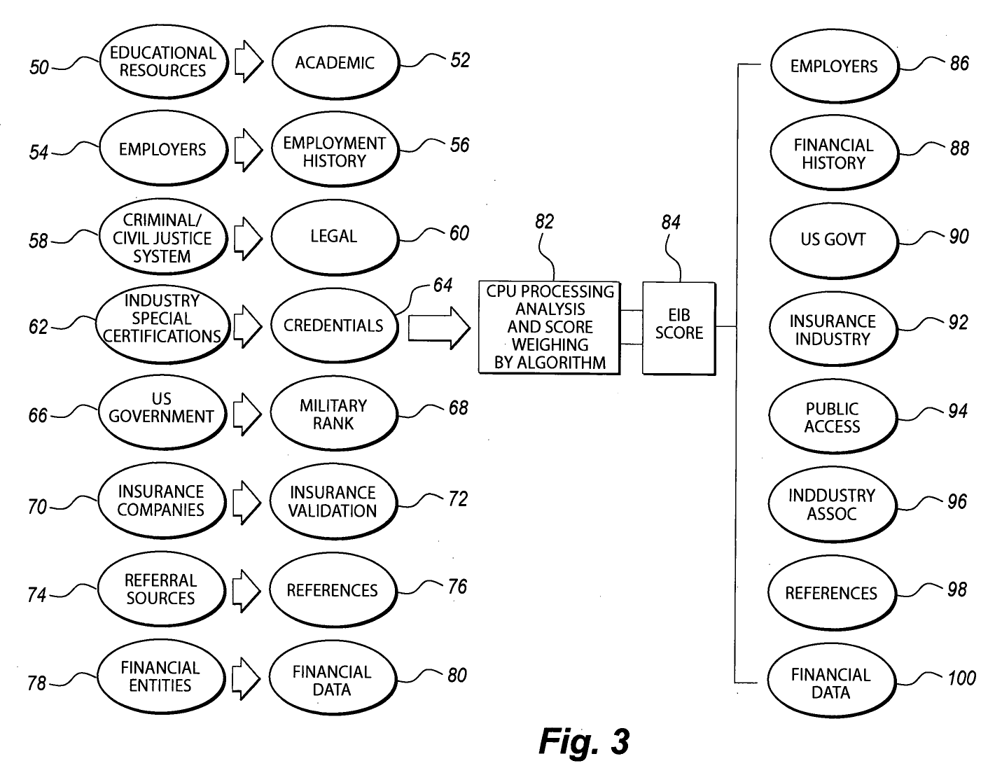

FIG. 3 is a flow chart diagram depicting input factors for analysis and score weighing according to the present system. Hence, a source of data can include educational resources 50, where academic records 52, such as high school and college transcripts, can be accessed. Another source of information may be from employers 54, where employment history 56, such as prior jobs and salary, can be accessed. Criminal/civil justice records can be accessed at 58, where legal information 60, such as prior convictions, can be accessed. Another source of data is industry specific certification records 62, where certification information 64, such as professional licenses, can be accessed. Yet another source of data can be U.S Government information 66, where government information, such as military records 68, can be accessed. Information from insurance companies 70 can be gathered, such as insurance loss history and premium payment validation 72. Yet another source of information can be referral sources 74, wherein specific references 76 can be accessed. Still yet another source of information is financial entities 78, where financial data 80 can be accessed.

This information is sent to the central processing unit (CPU) 82 for processing, analysis and score weighing in accordance with the teachings of the present invention. The analysis and score weighing is done by algorithm application of industry specific parameters. A weighted score 84 can then be assigned to that person. With the teachings of this invention, it is possible to commercially distribute weighted scores/sub-scores from applicant files of a particular segment (e.g. employment history), (insurance experience), or a group of factors (e.g. academic, military rank, and financial data), or all the factors. The weighted score 84 can then be disseminated as requested to member entities, such as employers 86, a financial entity 88, a government entity 90, an insurance company 92, public access 94, an industry association 96, a specific court 98, or some other entity 100. The listings 86, 88, 90, 92, 94, 96, 98 and 100 are meant to be illustrative only.

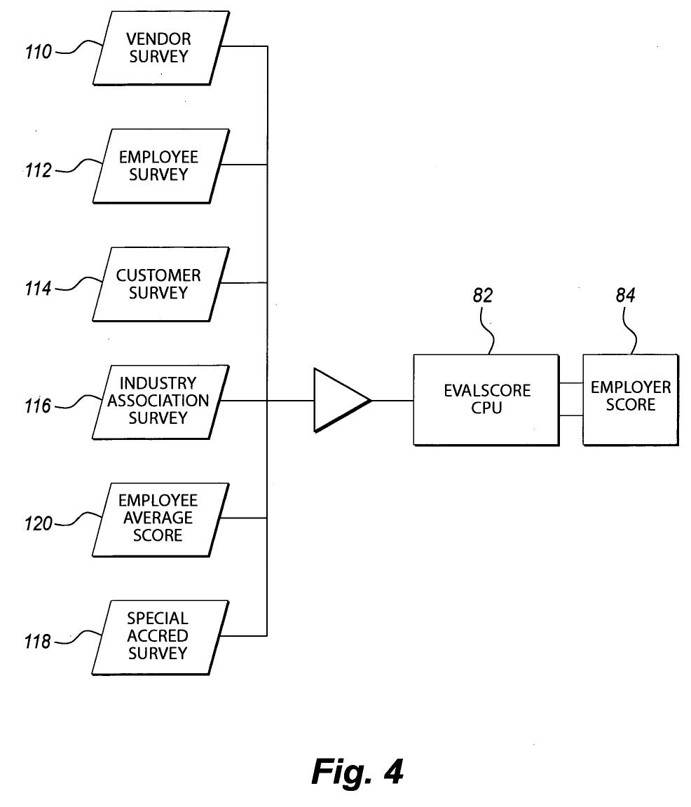

Referring now to FIG. 4, a data flow chart of the third embodiment, which is the most preferred embodiment of this disclosure, illustrating the generation of an employer score based on multiple surveys will now be described. This embodiment allows the employee the ability to participate in the evaluation of the employer. This component will be included in the index criteria along with evaluation by vendors, by customers, by industry associations, and by special accreditation organizations. The evaluation is calculated and weighted via the algorithm for the actual score.

As employers under the weighted score system provide input into the overall scoring on each applicant, this preferred system allows for the employee to anonymously rate the employer in an employee satisfaction category to be weighted in the overall evaluation. It has been found that corporations utilize proprietary surveys for employees in order to determine the strengths and weaknesses of each division and recommendations for improvement. Employers can use these results to assist in recruiting other competent employees or in advertising to the general public. In the most preferred embodiment, the system can be adapted to include means for parents to evaluate teachers. The process herein disclosed will provide an incentive for teachers to achieve improvement and excellence in the classroom.

FIG. 4 depicts the data that will be entered into the central processor unit 82 that receives and processes the survey data. As noted earlier, like numbers appearing in the various figures refer to like components. More specifically, the survey data includes a vendor survey 110, an employee survey 112, a customer survey 114, an industry association survey 116, and a special accreditation survey 118. Each survey is a questionnaire designed specifically to ascertain the credentials (i.e., qualifications, skills, competence, etc.) of the surveyed party. FIG. 4 also depicts the employee average score 120 that would be an average score of all employees which is utilized in the computation via the algorithm means, and where the calculation is carried out within the central processor unit 82. The weighted score 84 can then be assigned to that employer. It should be noted that in the below description, the entity that responds to the survey is referred to as the respondent; the party that views and participants in the survey results is referred to as the participant; and the entity being surveyed (i.e., the party being reviewed) is referred to as the surveyed party.

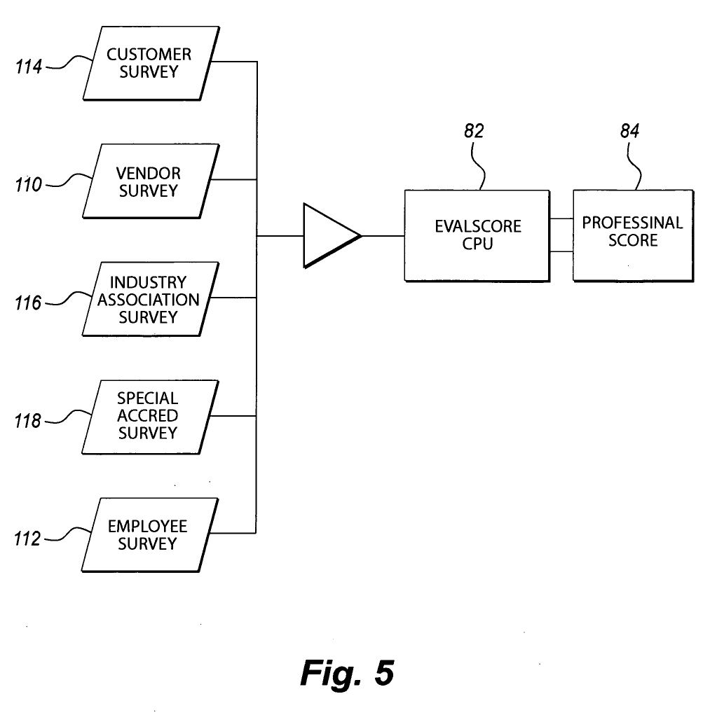

FIG. 5 is a data flow chart of the third and most preferred embodiment of this disclosure illustrating the generation of a professional score based on multiple surveys. Hence, the data being transmitted to the central processing unit 82 includes customer surveys 114, vendor surveys 110, association surveys 116, special accreditation surveys 118 and employee surveys 112. A weighted score 84 is generated via the central processing unit 82 as previously described.

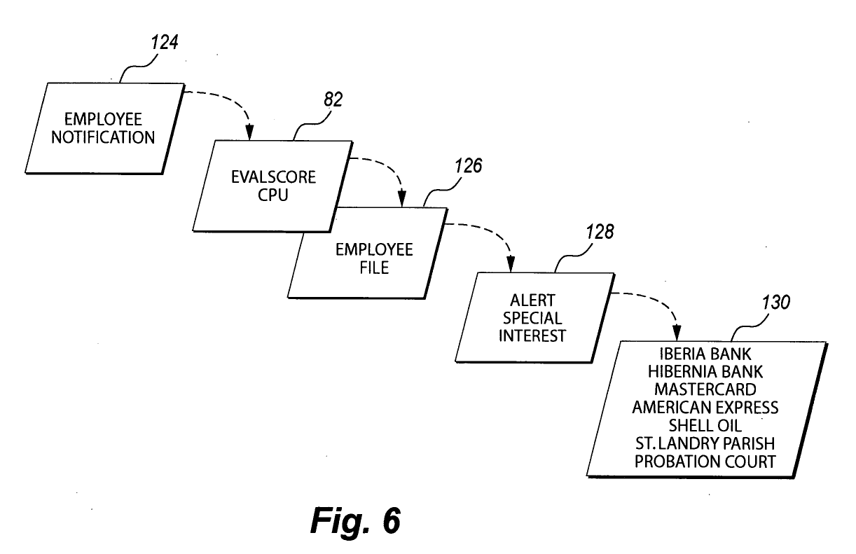

Referring now to FIG. 6, a data flow chart of the third and most preferred embodiment of this disclosure showing the generation of alert transmissions to selected participants, will now be described. An alert special interest provision is disclosed to provide instantaneous notification of any significant changes to the employer/employee/applicant file, such as, for example, job termination, re-hire, score reduction, etc. The alert function is provided to special interest entities, also referred to as participants, such as insurance companies, licensing boards, banks, credit companies, courts, etc. Special interest entities (participants in this embodiment) will be able to “park” on an applicant's file for change notification alerts. In the most preferred embodiment, a special interest group with authorization of the applicant may monitor the score and conditions of the applicant, where the authorization is granted in part by the payment of an authorization fee.

As illustrated according to the data flow of FIG. 6, and based upon predetermined criteria, once a survey score declines/exceeds a threshold, an employer signal is generated at 124, and this signal notification 124 is transmitted to the central processing unit 82. As an example, XYZ Bank makes a loan to an applicant based upon his “Evalscore” (Employment Strength/Weakness) and Financial Score, based upon existing performance numbers. The bank makes the loan at 8% interest with provisions that the applicant meet or exceed his loan based numbers, and should the applicant's performance cause a decline in the Evalscore, the bank could use this opportunity on a variable loan to increase the loan rate of interest to reflect the increased risk of the applicant. Therefore, at the point of sale, the applicant would execute authority for the bank to “park” on the applicant's file as a Special Interest Party (SIP) for alert notification. The bank could use the same model to reduce the applicant's rate of interest if the score improves. This will give the employee the incentive to achieve excellence. Additionally, this could also work with insurance companies for increase/decrease in insurance premiums based upon insurance performance; i.e., risk versus reward.

As seen in FIG. 6, the initiation of the signal notification 124 is downloaded and stored in the employee file 126, which, in turn, will generate an alert 128. As per the teachings of this disclosure, the generation of the alert 128 is transmitted to various participants, as seen at 130. The participants will include bank entities, credit entities, court entities, insurance company entities, etc. It should be noted that list is illustrative only.

As per the teachings of the present invention, lenders with an interest in the applicant (i.e., the surveyed party) due to loans, credit cards, etc., will be able to receive instant electronic notification of score changes, job changes, etc. Court systems will be able to monitor defendants (i.e., the surveyed party) for probation violations, child support, garnishments, change of job, change of address, etc. Unlike the present method of anticipating a claim, Insurance companies will be able to monitor the insured (i.e., the surveyed party), like contractors, for example, and if poor performance trends deteriorate the score of the applicant, insurance companies will be able to issue non-renewals and escape risk or surcharge the premium for the exposure at renewal. General contractors will want to monitor sub-contractors for risk management. If a sub-contractor is receiving consumer complaints that are unresolved, the sub-contractor will realize that it is at risk of losing general contractor's relationship. Also, if a surveyed party's performance is poor, insurance programs may be non-renewed resulting in the surrender of the relationship. Insurance companies will be able to provide savings to clients via reduced premiums if the party being reviewed (i.e., the party who is being ranked via the survey) maintains an acceptable weighted score. Additionally, licensing boards could participate in the instant notification of weighted scores when, for instance, an entity under license review by the licensing board such as a contractor falls below a predetermined threshold score and places the public at risk. Hence, the license board could choose to non-renew, or provisionally accept, based in part on the weighted scores. Further, company vendors could participate in the special interest party program for instant notification of potential problems with business relationships.

As an example, an insurance company will require a benchmark weighted score for pricing based upon past insurance performance (risk versus reward), where the insurance company will activate the alert function on a surveyed weighted party file as a special interest party. Therefore, the insurance company can establish parameters for instant notification of customer complaints of poor performance, misrepresentations, or other established underwriting parameters that will provide the insurance company with decision making criteria to elect to non-renew coverages before unnecessary losses occur, thus saving the insurance company unnecessary claims expense. Hence, instant notification provides warnings to participants that changes are occurring and action may be needed to protect themselves from loss. The system herein disclosed protects banks and credit companies from financial losses and the recurrence of another sub-prime meltdown due to the internal parameters established for employment performance disclosure, validation, evaluation, assessment with subsequent scoring incorporating real time alert monitoring. The system also protects insurance companies from unnecessary claim expense by real time disclosure of score modification and complaint provisions for early intervention and/or issuance of non-renewal or cancellation of poor performing risks. The system protects vendors from declining relationships and protects courts from unnecessary investigative expense in processing garnishments due to the instant notification of employment termination and/or re-employment. Additionally, the system protects general contractors by poor performing sub contractors. The system also protects licensing boards from the renewals of poor performing licensees.

The above methodology is particularly applicable to the insurance and finance industry. Unlike current underwriting tools available, this method may be used to provide real time insurance loss experience and scoring assessment encompassing only insurance indicators of each specific risk with the incorporation of interactive performance monitoring in a single database.

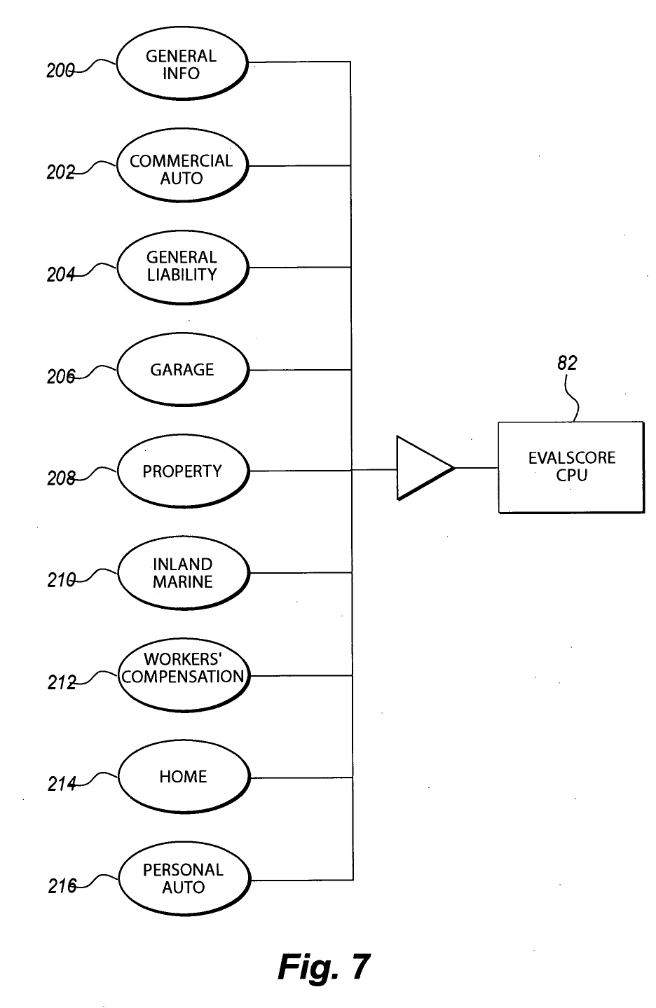

As shown in FIG. 7, the collection, storage and score assessment of insurance loss experience and performance indicators provided by insurance companies on behalf of insureds can be calculated in a manner similar to that described above, with the collection of general information 200, such as the named insured, policy year, policy number, line of coverage, etc.; along with the insurance specific information, such as commercial auto insurance 202, general liability insurance 204, garage insurance 206, property insurance 208, inland marine insurance 210, workers' compensation 212, home insurance 214 and personal auto insurance 216. It should be understood that this listing is shown for exemplary purposes only, and any insurance-related factors may be used, such as, for example, health insurance, etc.

Specifically, the mathematical algorithm assessment is applied by CPU 82 for numerical score determination based upon written premiums, earned premiums, incurred losses, paid losses, subrogations/recoverables, loss adjustment expenses and established loss reserves, as well as score modification by actual performance indicators of insurance premium payment history, late payment history, policy cancellations, audit payment history, and policy underwriting accuracy and/or misrepresentations, etc. and consumer complaints. It should be understood that this listing of factors is provided for exemplary purposes only.

This method allows for the collection, evaluation, and assessment of real time loss history and insurance performance as provided by insurance company downloads by electronic media; point of sale purchase of real time loss information by insurers or other authorized parties scored by actual performance experience; nominal fees charged based on years of data, lines of coverage, etc.; and real time performance trend monitoring and score modification provided by insurance company downloads to the present system of loss history updates and specific insurance performance indicators such as insurance payment history, non-renewals, cancellations, etc. A website implementation may incorporate commercial insurance client provisions for electronic alerts created by poor performance indicators filed in the form of complaints directly to insurance companies/the present method by customers of the insured, such as that shown in FIG. 6. These alerts may provide an opportunity for the insurance company to intervene for dispute resolution prior to economic loss and/or the cancellation or non-renewal of poor performing risks.

With appropriate authorization, customers will have access to the present system for full disclosure and evaluation of their relationship prior to engagement, thus preventing economic loss created by poor workmanship, incomplete work or fraud. The consumer further has the ability to file a meaningful complaint on work performed directly to the insurance company of the insured. Poor performers will have an incentive to provide satisfactory work, as the impact will cost them money in the form of higher insurance premiums or the risk of the insurance program in its entirety.

Implementation of the above method will allow insurance companies to save costs through the elimination of the manual loss history request and retrieval system presently utilized, which requires personnel to fulfill requests. Costs savings are further provided though lower expense ratios generated by underwriting automation. Insurance companies will be able to slot rate insureds after the merging of data based on the present method converted into a reliable numerical assessment thereby reducing underwriting costs. Further, delays in the receipt of loss history of previous insurers are eliminated. The present method requires manual requests in addition to time frame parameters that hinder the transfer of business.

Real time performance trending of insureds is further provided by the present method within the insurance category as provided herein. In addition to real time downloads of loss history changes, the present method provides electronic notification to insurers and other interested authorized parties of “hot spots” in the insured's performance, in the form of complaints filed by dissatisfied customers. Notification provides the insurance company or authorized party with an opportunity for early intervention prior to loss. As an example, the John Doe Service Company performs work for Chevron USA with a required Evalscore of 600 or better. The John Doe Service Company experiences financial difficulty and many long-time quality employees depart. Work performance deteriorates thus decreasing John Doe's score below required threshold, and Chevron USA terminates the relationship prior to economic loss.

Using the above method, general contractors will be able to monitor sub-contractors and require minimum scores for bid participation; license and permit Sections can monitor Evalscores for all licensees and receive notification when performance is unacceptable, requiring regulatory action. With specific regard to insurance, the method encourages the insured to achieve satisfaction. With the alert notification function, insureds will be forced to strive for excellence in order to reduce complaints, thus reducing loss and premium costs.

The present method further allows for the early detection of exposure variances. After the insurer has written the insured and inspected risk, the insured may deviate from the initial exposure and begin tasks that are not warranted in the original rating base. With the electronic alert function, if the insurer receives a complaint on the insured for a scope of work not included in the original application, the insurer has an opportunity to request the cease and desist of the activity or issue notice of cancellation or non renewal for misrepresentations.

Using the present methodology, the insured will no longer be metaphorically held hostage by current insurers due to the failure to receive previous loss history in a timely fashion in order to bid the insurance program.

As the insurance industry has embraced credit underwriting tools for the underwriting of personal insurance coverages, such as, for example, auto, home, watercraft, etc., many insureds are being penalized by higher insurance premiums due to their late payments or high account balances due to Visa®, MasterCard®, home mortgage lenders, etc., as these actions tend to lower credit scores for individuals.

The above inventive method solidifies the basic insurance principal of rating the insured based upon actual insurance experience with actual loss history of the insured in relation to earned premium charges, as well as score modification based upon actual insurance performance indicators.

Present systems and methods, such as Choice Point's “CLUE” Comprehensive Loss Underwriting Exchange, for example, do not make reference to premium payments or earned premiums by line of coverage. Instead, they only disclose actual claim payments and do not make reference to reserves, instead only stating conditions as “open” or “closed”. An open claim could reflect a reserve of $10,000.00 or $10,000,000.00, for example.

Thus, a “paid claim” of $5,000.00 would have minimal effect on an account that has a $20,000.00 premium; i.e. $5000.00/$20,000.00=25% loss ratio. However, if the $5,000.00 payment is made on behalf of an account that generates only $2,600.00 in premiums, the resulting loss ratio is 192%. Thus, a great deficiency exists under this system, which is solved by the above inventive method.

Unlike that shown in the prior art, the present method takes into consideration years of experience with actual premium payments, written premiums computed for earned premiums vs. actual losses incurred (paid and reserved) adjusted for fault/non-fault incidents, motor vehicle violations with assessment modifications by actual insurance performance indicators, such as late payments, cancellations, non-renewals, underwriting misrepresentations, (non-disclosed drivers, etc.) scored in real time by algorithmic assessment for final score determination. The above method is based on the totality of insurance performance and does not incorporate the possible discriminatory application of non-related performance indicators, such as third party obligations of debt as provided by the “Beacon” credit score presently utilized in the underwriting process.

It is to be understood that the present invention is not limited to the embodiments described above, but encompasses any and all embodiments within the scope of the following claims.

I claim:

1. A method of collecting and distributing confidential insurance loss history and account performance information comprising the steps of:
collection and storage of real time insurance loss history and account performance information in a database;
transmitting authorization to view said real time insurance loss history and account performance information via a surveyed party processor operatively associated with a control means;
authenticating and authorizing third parties' access to said database; and,
presenting said real time insurance loss history and account performance information in a first format via said control means, wherein said control means is operatively associated with said database.

2. The method of collecting and distributing confidential insurance loss history and account performance information as recited in claim 1, further comprising the steps of:
providing a participant processor in communication with said control means; and,
requesting authorization to download said real time insurance loss history and account performance information with said participant processor.

3. The method of collecting and distributing confidential insurance loss history and account performance information as recited in claim 2, wherein said step of requesting authorization to download said real time insurance loss history and account performance information includes paying a request fee by a participant in order to view said real time insurance loss history and account performance information.

4. The method of collecting and distributing confidential insurance loss history and account performance information as recited in claim 3, wherein said step of transmitting authorization to make available said real time insurance loss history and account performance information via the participant processor includes paying a user fee by a surveyed party in order to post the surveyed party's information to the database.

5. The method of collecting and distributing confidential insurance loss history and account performance information as recited in claim 4, wherein said step of presenting said real time insurance loss history and account performance information in a first format includes calculation of a weighted score of said real time insurance loss history and account performance information.

6. The method of collecting and distributing confidential insurance loss history and account performance information as recited in claim 5, wherein said real time insurance loss history and account performance information is selected from the group consisting of: information related to commercial auto insurance, general liability insurance, garage insurance, property insurance, inland marine insurance, workers' compensation, health insurance, home insurance, commercial auto insurance and personal auto insurance.

7. The method of collecting and distributing confidential insurance loss history and account performance information as recited in claim 5, wherein said real time insurance loss history and account performance information includes prior employment information.

8. The method of collecting and distributing confidential insurance loss history and account performance information as recited in claim 5, wherein said real time insurance loss history and account performance information includes insurance-related information selected from the group consisting of: insurance payment history, non-renewal history, cancellations of insurance and prior misrepresentations.

9. The method of collecting and distributing confidential insurance loss history and account performance information as recited in claim 5, wherein said real time insurance loss history and account performance information is sub-divided into categories including prior claim performance, prior customer satisfaction, insurance premium size, insurance policy duration and prior complaint filings.

10. The method of collecting and distributing confidential insurance loss history and account performance information as recited in claim 5, further comprising the step of transmitting an alert signal to the participant based upon said real time insurance loss history and account performance information.

11. The method of collecting and distributing confidential insurance loss history and account performance information as recited in claim 10, wherein said alert signal is selectively transmitted to the participant upon matching of said real time insurance loss history and account performance information to at least one factor.

12. The method of collecting and distributing confidential insurance loss history and account performance information as recited in claim 11, further comprising the step of continuously monitoring said database for a change in said at least one factor, and transmitting said alert signal upon detection of the change.
